(19) United States
(12) Patent Application Publication
(10) Pub. No.: US 2025/0269807 A1
(43) Pub. Date: Aug. 28, 2025

(54) VEHICLE LOWER STRUCTURE

(71) Applicant: TOYOTA JIDOSHA KABUSHIKI KAISHA, Aichi-ken (JP)

(72) Inventors: Shigeyuki INOUE, Toyota-shi (JP); Naoya KAWAMOTO, Nisshin-shi (JP); Takahito SAKURABA, Seto-shi (JP); Kenichi KAKISHITA, Nagoya-shi (JP); Kohei TAKASE, Susono-shi, (JP); Kai MIYAMURA, Toyota-shi, Aichi-ken (JP); Kazuya KUMAZAWA, Nagoya-shi, Aichi-ken (JP)

(21) Appl. No.: 19/064,693

(22) Filed: Feb. 27, 2025

(30) Foreign Application Priority Data
Feb. 28, 2024 (JP) 2024-028875

(51) Int. Cl. B60R 13/08; B60H 1/24; B60L 50/60; B60N 3/04; B62D 21/03; B62D 25/20

(52) U.S. Cl. CPC B60R 13/083; B60H 1/246; B60N 3/042; B62D 21/03; B62D 25/20; B60L 50/66

(57) ABSTRACT

A vehicle lower structure includes a floor carpet, an intermediate member disposed below the floor carpet, a power storage device disposed below the intermediate member, and a seat disposed above the floor carpet, wherein the intermediate member includes a first member underlying the seat in an up/down direction, and a second member having an underlying portion underlying the seat in the up/down direction and a non-underlying portion not underlying the seat in the up/down direction, and flame retardancy of the first member is higher than flame retardancy of the second member.

### CROSS REFERENCE TO RELATED APPLICATIONS

This nonprovisional application is based on Japanese Patent Application No. 2024-028875 filed on Feb. 28, 2024, with the Japan Patent Office, the entire contents of which are hereby incorporated by reference.

### BACKGROUND

### Field

The present disclosure relates to a vehicle lower structure.

### Description of the Background Art

As disclosed in Japanese Patent Laying-Open No. 2023-139898, a vehicle lower structure including a power storage device is known.

### SUMMARY

Although it is preferable for a vehicle lower structure including a power storage device to have a higher flame retardancy, a member having flame retardancy is often not inexpensive. An object of the present disclosure is to provide a vehicle lower structure that can achieve flame retardancy at a lower cost.

A vehicle lower structure in the present disclosure includes a floor carpet forming a portion of a vehicle compartment, an intermediate member disposed below the floor carpet, a power storage device disposed below the intermediate member, and a sea disposed above the floor carpet, wherein the intermediate member includes a first member underlying the seat in an up/down direction, and a second member having an underlying portion underlying the seat in the up/down direction and a non-underlying portion not underlying the seat in the up/down direction, and flame retardancy of the first member is higher than flame retardancy of the second member.

According to the above configuration, by ensuring a high flame retardancy at the portion underlying the seat in the up/down direction, and reducing the used amount of an expensive resin having flame retardancy at the portion not underlying the seat in the up/down direction, it is possible to provide a vehicle lower structure that can achieve flame retardancy at a lower cost.

In the above disclosure, the vehicle lower structure may include a lower frame including a pair of side members, a front member connecting front portions of the pair of side members, a rear member connecting rear portions of the pair of side members, and a cross member connecting intermediate portions of the pair of side members in a vehicle front/rear direction, wherein the intermediate member may be disposed to fill a space formed by a plurality of members among the pair of side members, the front member, the cross member, and the rear member, inside the plurality of members.

According to the above configuration, the intermediate member can be disposed without any gap in the space formed by the plurality of members among the pair of side members, the front member, the cross member, and the rear member, inside the plurality of members.

In the above disclosure, heat conductivity of the second member may be lower than heat conductivity of the first member.

According to the above configuration, for the second member having the non-underlying portion not underlying the seat in the up/down direction, of the intermediate member, heat from the power storage device is likely to be transferred to an occupant sitting in the seat. Therefore, by lowering heat conductivity of this portion, the heat from the power storage device can be suppressed from being transferred to the feet of the occupant sitting in the seat.

The vehicle lower structure in the above disclosure may further include a metal sheet disposed between the floor carpet and each of the first member and the second member.

According to the above configuration, heat generated in the power storage device and directed upward, for example, can be dispersed in a horizontal direction at a height position of the metal sheet.

In the above disclosure, the metal sheet may be disposed to contact the cross member.

According to the above configuration, the heat generated in the power storage device and directed upward, for example, can be dispersed in the horizontal direction at the height position of the metal sheet and transferred to the cross member.

In the above disclosure, the metal sheet may be disposed to entirely cover the first member, the second member, and the cross member from above.

According to the above configuration, it is possible to prevent air or the like from flowing from above the metal sheet toward the intermediate member below the metal sheet, and to obtain a higher flame retardant effect below the metal sheet.

The vehicle lower structure in the above disclosure may further include an expansion member disposed between the cross member and the power storage device and expanding at least in the up/down direction by being heated.

According to the above configuration, the expansion member expands by heating, and can increase the distance between the intermediate member and the power storage device by expanding and increasing its volume.

The vehicle lower structure in the above disclosure may include a duct through which an airflow generated by an air conditioning system for adjusting temperature in the vehicle compartment flows, wherein the duct may have an outlet, and the outlet may be provided to provide the airflow at a position between the first member or the second member and the power storage device.

According to the above configuration, the intermediate member can be cooled by the airflow from the air conditioning system, and the heat from the power storage device can be suppressed from being transferred to the occupant.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a side view showing a vehicle 1 including a vehicle lower structure 10 in a first embodiment.

FIG. 2 is a plan view showing a vehicle compartment 13 of vehicle 1 in the first embodiment.

FIG. 3 is a cross sectional view of vehicle lower structure 10 in the first embodiment as viewed from a front side of vehicle 1, which corresponds to a cross sectional view taken along a line III-III in FIG. 4 and viewed in a direction indicated by arrows.

FIG. 4 is a cross sectional view of vehicle lower structure 10 in the first embodiment as viewed from a left side of vehicle 1, which corresponds to a cross sectional view taken along a line IV-IV in FIG. 3 and viewed in a direction indicated by arrows.

FIG. 5 is an enlarged view of a portion in FIG. 4.

FIG. 6 is an exploded cross sectional view of vehicle lower structure 10 in the first embodiment, which corresponds to FIG. 4.

FIG. 7 is an exploded perspective view of vehicle lower structure 10 in the first embodiment.

FIG. 8 is a cross sectional view showing a vehicle lower structure 10A in a second embodiment, which corresponds to FIG. 5 in the first embodiment.

FIG. 9 is a cross sectional view showing a vehicle lower structure 10B in a third embodiment, which corresponds to FIG. 5 in the first embodiment.

FIG. 10 is a cross sectional view showing a vehicle lower structure 10C in a fourth embodiment, which corresponds to FIG. 5 in the first embodiment.

### DESCRIPTION OF THE PREFERRED EMBODIMENTS

Hereinafter, embodiments of the present disclosure will be described. When the number, amount, or the like is mentioned in the embodiments described below, the scope of the present disclosure is not necessarily limited to that number, amount, or the like unless otherwise specified. Each component is not necessarily essential to the present disclosure unless otherwise specified. The same parts and corresponding parts will be designated by the same reference numerals, and the same description may not be repeated.

Arrows F, B, U, D, L, and R in the drawings used in the following description indicate directions with respect to a vehicle, and arrow F indicates a “forward direction”, arrow B indicates a “backward direction”, arrow U indicates an “upward direction”, arrow D indicates a “downward direction”, arrow L indicates a “left direction”, and arrow R indicates a “right direction”.

### First Embodiment

### (Vehicle 1)

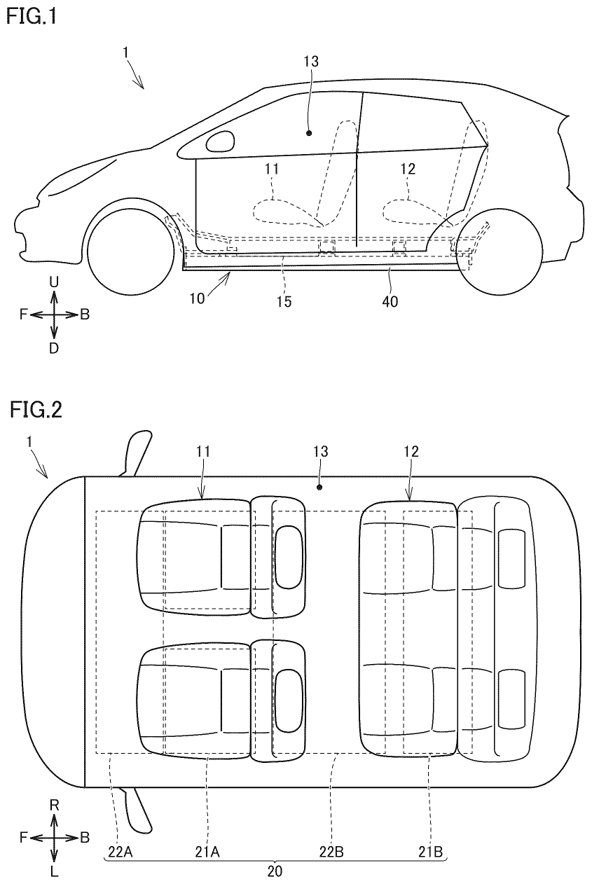

Referring to FIGS. 1 to 7, a vehicle 1 including a vehicle lower structure 10 in a first embodiment will be described. FIG. 1 is a side view showing vehicle 1, and FIG. 2 is a plan view showing a vehicle compartment 13 of vehicle 1.

Vehicle 1 is, for example, an electrically powered vehicle such as an electric vehicle or a hybrid vehicle that can be driven by a motor. Vehicle 1 includes vehicle compartment 13, seats 11 and 12 in which occupants can sit, and vehicle lower structure 10 (FIG. 1).

### (Vehicle Lower Structure 10)

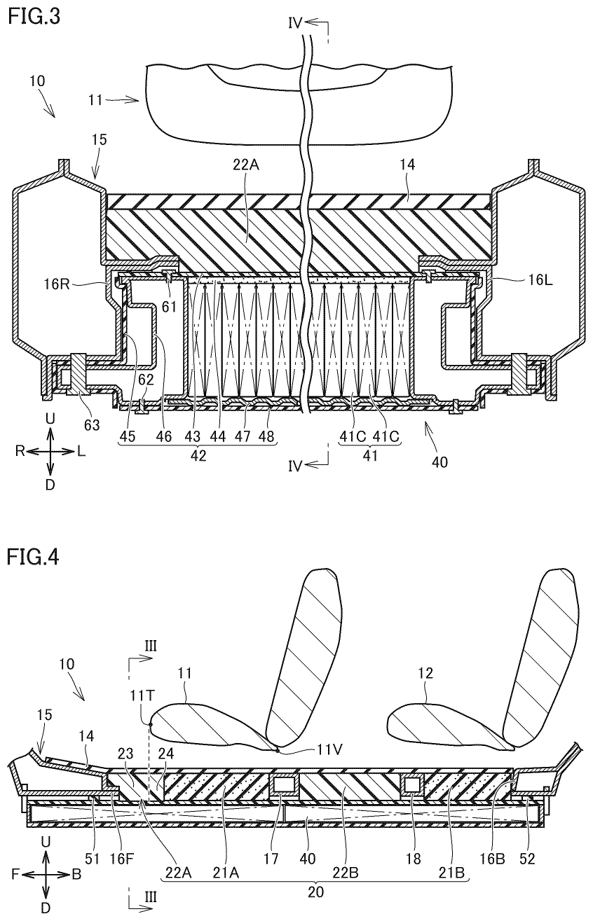

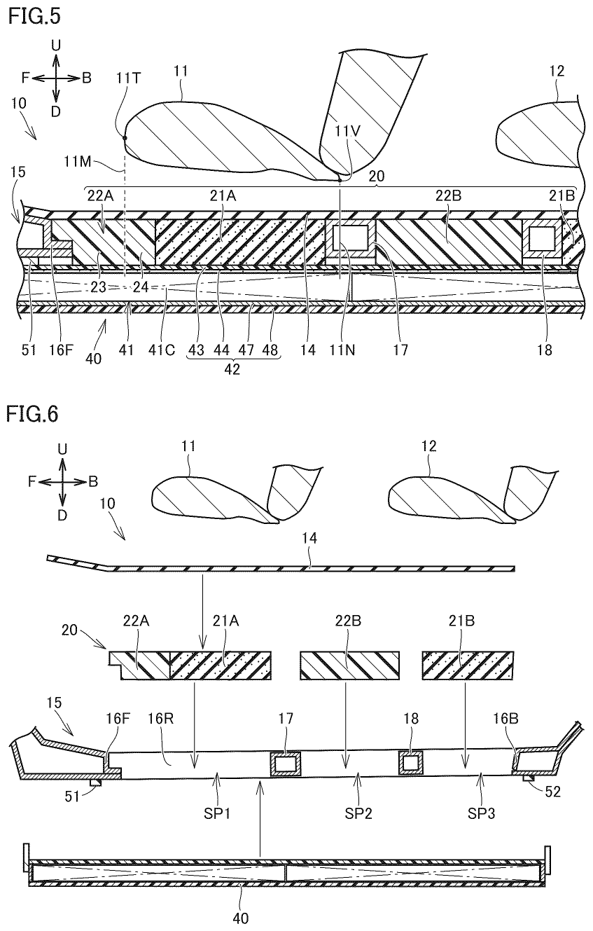

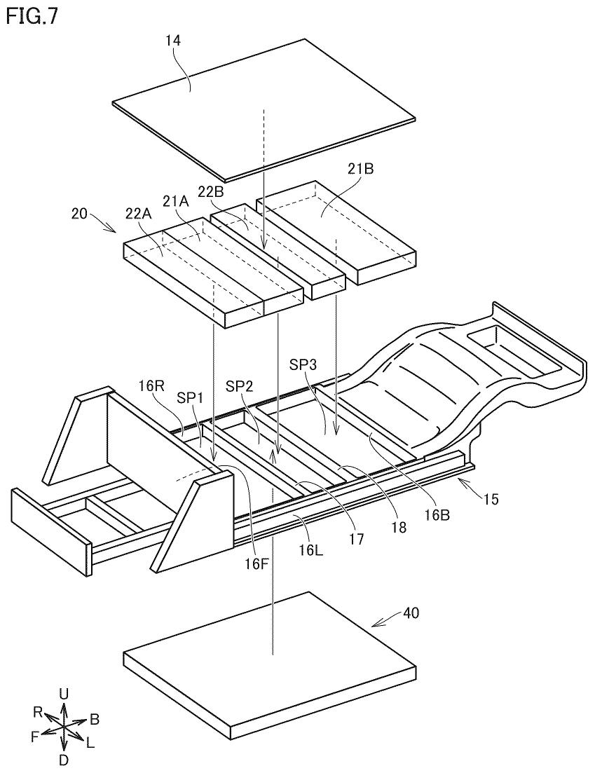

FIG. 3 is a cross sectional view of vehicle lower structure 10 as viewed from a front side of vehicle 1, which corresponds to a cross sectional view taken along a line III-III in FIG. 4 and viewed in a direction indicated by arrows. FIG. 4 is a cross sectional view of vehicle lower structure 10 as viewed from a left side of vehicle 1, which corresponds to a cross sectional view taken along a line IV-IV in FIG. 3 and viewed in a direction indicated by arrows. FIG. 5 is an enlarged view of a portion in FIG. 4. FIG. 6 is an exploded cross sectional view of vehicle lower structure 10, which corresponds to FIG. 4. FIG. 7 is an exploded perspective view of vehicle lower structure 10.

As shown in FIGS. 3 to 7 (in particular, FIGS. 6 and 7), vehicle lower structure 10 includes a floor carpet 14, an intermediate member 20, a lower frame 15, and a power storage device 40.

### (Lower Frame 15)

Lower frame 15 supports power storage device 40, for example. Here, lower frame 15 (FIG. 7) includes a pair of side members 16L and 16R, a front member 16F, a rear member 16B, and cross members 17 and 18. Front member 16F extends in a vehicle width direction and connects front portions of the pair of side members 16L and 16R. Rear member 16B extends in the vehicle width direction and connects rear portions of the pair of side members 16L and 16R. Each of cross members 17 and 18 also extends in the vehicle width direction and connects intermediate portions of the pair of side members 16L and 16R in a vehicle front/rear direction.

Spaces (spaces SP1, SP2, and SP3) are each formed by a plurality of members among the pair of side members 16L and 16R, front member 16F, cross members 17 and 18, and rear member 16B, inside the plurality of members. In the present embodiment, the pair of side members 16L and 16R, front member 16F, and cross member 17 are disposed in a rectangular frame shape, and space SP1 (FIGS. 6 and 7) is formed inside these members. Similarly, the pair of side members 16L and 16R and cross members 17 and 18 are disposed in a rectangular frame shape, and space SP2 is formed inside these members.

The pair of side members 16L and 16R, cross member 18, and rear member 16B are disposed in a rectangular frame shape, and space SP3 is formed inside these members. Vehicle lower structure 10 is not provided with a member generally called a floor panel or the like, which is constituted by a metal steel plate or the like. Vehicle lower structure 10 penetrates through spaces SP1, SP2, and SP3 in an up/down direction at portions where spaces SP1, SP2, and SP3 are provided.

### (Intermediate Member 20)

Intermediate member 20 is disposed below floor carpet 14. Here, intermediate member 20 is disposed to fill at least one of spaces SP1, SP2, and SP3 described above. Intermediate member 20 includes first members 21A and 21B and second members 22A and 22B. First members 21A and 21B and second members 22A and 22B are constituted by members including a foamed resin, for example, and each have a block-like shape. First members 21A and 21B and second members 22A and 22B can be constituted by members that are lighter than metal and softer than metal.

First member 21A and second member 22A are disposed to be adjacent to each other in a horizontal direction, for example. First member 21A and second member 22A integrated with each other have substantially the same size and shape as those of space SP1. First member 21A and second member 22A are disposed to fill space SP1 (FIGS. 6 and 7).

Second member 22B has substantially the same size and shape as those of space SP2, and second member 22B is disposed to fill space SP2. First member 21B has substantially the same size and shape as those of space SP3, and first member 21B is disposed to fill space SP3.

Referring to FIG. 5, as will be described in detail later, first member 21A is disposed to underlie seat 11 in the up/down direction. On the other hand, second member 22A includes an underlying portion 24 underlying seat 11 in the up/down direction and a non-underlying portion 23 not underlying seat 11 in the up/down direction.

### (Floor Carpet 14 and Seats 11, 12)

Floor carpet 14 is a member forming a portion of vehicle compartment 13 above floor carpet 14. Seats 11 and 12 are disposed above floor carpet 14. As shown in FIGS. 1 and 2, a pair of seats 11 are disposed to be arranged in a right/left direction at positions above floor carpet 14 inside vehicle compartment 13, and seat 12 is disposed behind the seats.

As shown in FIG. 6, floor carpet 14 is disposed above intermediate member 20 (first members 21A and 21B and second members 22A and 22B). Floor carpet 14 may be disposed to directly contact upper surfaces of first members 21A and 21B and second members 22A and 22B. Between floor carpet 14 and each of first members 21A and 21B and second members 22A and 22B, a fixture for preventing movement of floor carpet 14, a structure for preventing slippage (a hook-and-loop fastener), or the like may be provided as appropriate. Although floor carpet 14 is constituted by one member in vehicle 1 in the present embodiment, floor carpet 14 may be constituted by a plurality of members.

### (Power Storage Device 40)

As shown in FIGS. 3 to 6, power storage device 40 is disposed below intermediate member 20 (first members 21A and 21B and second members 22A and 22B). Power storage device 40 (FIG. 3) includes a power storage module 41 and a case 42. Power storage module 41 includes a plurality of power storage cells 41C accommodated by case 42 and arranged in the horizontal direction. Power storage cell 41C is configured to include a battery that stores electric power to be supplied to the motor. The plurality of power storage cells 41C may be stacked in the vehicle width direction, or may be stacked in the vehicle front/rear direction.

Case 42 (FIG. 3) has a top plate 43, an adhesive 44, side walls 45, inner walls 46, a support member 47, and a bottom plate 48. Top plate 43, a pair of side walls 45, and bottom plate 48 are made of FRP, for example, these members constitute an outer structure of case 42, and adhesive 44, inner walls 46 and support member 47, and power storage module 41 are disposed in this structure.

Power storage module 41 (each of the plurality of power storage cells 41C) is bonded to top plate 43 with adhesive 44. Inner walls 46 are disposed on both outer sides of power storage module 41 (the plurality of power storage cells 41C) in a stacking direction. Support member 47 has a plate-like shape, and is disposed between power storage module 41 and bottom plate 48. Each inner wall 46 is integrated with top plate 43 by a fixture 61, and is integrated with bottom plate 48 by a fixture 62.

Power storage device 40 configured as described above is fastened to, for example, side members 16L and 16R of lower frame 15, by a plurality of fasteners 63 (FIG. 3). Thereby, power storage device 40 is supported by lower frame 15. Seals 51 and 52 (FIGS. 4 and 6) may be disposed between power storage device 40 (top plate 43) and lower frame 15 (front member 16F, side member 16R).

As shown in FIG. 6, power storage device 40 is disposed below intermediate member 20 (first members 21A and 21B and second members 22A and 22B). Power storage device 40 (top plate 43) may be disposed to directly contact lower surfaces of first members 21A and 21B and second members 22A and 22B (see also FIG. 3).

### (Intermediate Member 20 and Flame Retardancy)

As described above, intermediate member 20 includes first members 21A and 21B and second members 22A and 22B. First members 21A and 21B are disposed to underlie seats 11 and 12 in the up/down direction. On the other hand, second members 22A and 22B have underlying portions underlying seats 11 and 12 in the up/down direction (underlying portion 24 underlying seat 11 in the case of second member 22A) and non-underlying portions not underlying seats 11 and 12 in the up/down direction (non-underlying portion 23 not underlying seat 11 in the case of second member 22A).

As shown in FIG. 5, for example, a reference line 11M passing through a front end portion 11T of seat 11 (here, a seat cushion) and extending downward in a vertical direction is defined, and a reference line 11N passing through a rear end portion 11V of seat 11 (here, the seat cushion) and extending downward in the vertical direction is defined. In the present embodiment, first member 21A is located between reference line 11M and reference line 11N in the vehicle front/rear direction (see also FIG. 2). Entire first member 21A is configured to underlie seat 11.

As shown in FIG. 5, for example, reference line 11M passing through front end portion 11T of seat 11 and extending downward in the vertical direction is defined. In the present embodiment, non-underlying portion 23 of second member 22A is disposed on a front side relative to reference line 11M, and underlying portion 24 of second member 22A is disposed on a rear side relative to reference line 11M.

Second member 22B (see FIG. 4) is configured such that a portion of second member 22B close to its rear end portion underlies seat 12 in the up/down direction, and most of second member 22B is disposed not to underlie seats 11 and 12 in the up/down direction.

Here, flame retardancy of first members 21A and 21B is configured to be higher than flame retardancy of second members 22A and 22B. For example, first members 21A and 21B are made of a resin material having flame retardancy higher than flame retardancy of the members constituting second members 22A and 22B.

The flame retardancy can be evaluated, for example, based on the UL (Underwriter's Laboratories) Standards (standards for UL Test No. 94) or the like. As a member for improving the flame retardancy, for example, a glass cloth, a carbon cloth made of carbon fibers, a fluorine fiber cloth made of fluorine fibers, a fluorine resin film, or the like can be utilized. For example, a member obtained by adding a halogen compound, antimony oxide, glass fibers, or the like to a resin material such as polybutylene terephthalate (PBT) serving as a base material may be used.

### (Functions and Effects)

As described above, in the present embodiment, floor carpet 14 is disposed above intermediate member 20 (first members 21A and 21B and second members 22A and 22B), and power storage device 40 is disposed below intermediate member 20 (first members 21A and 21B and second members 22A and 22B). Vehicle lower structure 10 is not provided with a member generally called a floor panel or the like, which is constituted by a metal steel plate or the like. When power storage device 40 is provided directly below the floor panel, the floor panel can exhibit flame retardancy.

In vehicle lower structure 10, first members 21A and 21B of intermediate member 20 underlie seats 11 and 12 in the up/down direction, and first members 21A and 21B of intermediate member 20 ensure a high flame retardancy. On the other hand, second members 22A and 22B of intermediate member 20 have the non-underlying portions not underlying seats 11 and 12 in the up/down direction, and the flame retardancy of second members 22A and 22B is lower than the flame retardancy of first members 21A and 21B.

By ensuring a high flame retardancy at the portions underlying seats 11 and 12 in the up/down direction, and reducing the used amount of an expensive resin having flame retardancy at the portions not underlying seats 11 and 12 in the up/down direction, it is possible to provide a vehicle lower structure that can achieve flame retardancy at a lower cost.

### Modification of the First Embodiment

As a modification of the first embodiment described above, heat conductivity of second members 22A and 22B may be configured to be lower than heat conductivity of first members 21A and 21B.

When a heat transfer path is considered for the portions of intermediate member 20 underlying seats 11 and 12 in the up/down direction (first members 21A and 21B), heat from power storage device 40 is transferred to the occupants sitting in seats 11 and 12 via intermediate member 20, floor carpet 14, and seats 11 and 12.

On the other hand, for the portions of intermediate member 20 not underlying seats 11 and 12 in the up/down direction (second members 22A and 22B), the heat from power storage device 40 is transferred to the feet of the occupants sitting in seats 11 and 12 without passing through seats 11 and 12.

That is, for the portions of intermediate member 20 not underlying seats 11 and 12 in the up/down direction (the non-underlying portions of second members 22A and 22B), the heat from power storage device 40 is likely to be transferred to the occupants sitting in seats 11 and 12. Therefore, by lowering heat conductivity of these portions (for example, the non-underlying portions of second members 22A and 22B), the heat from power storage device 40 can be suppressed from being transferred to the feet of the occupants sitting in seats 11 and 12.

### Second Embodiment

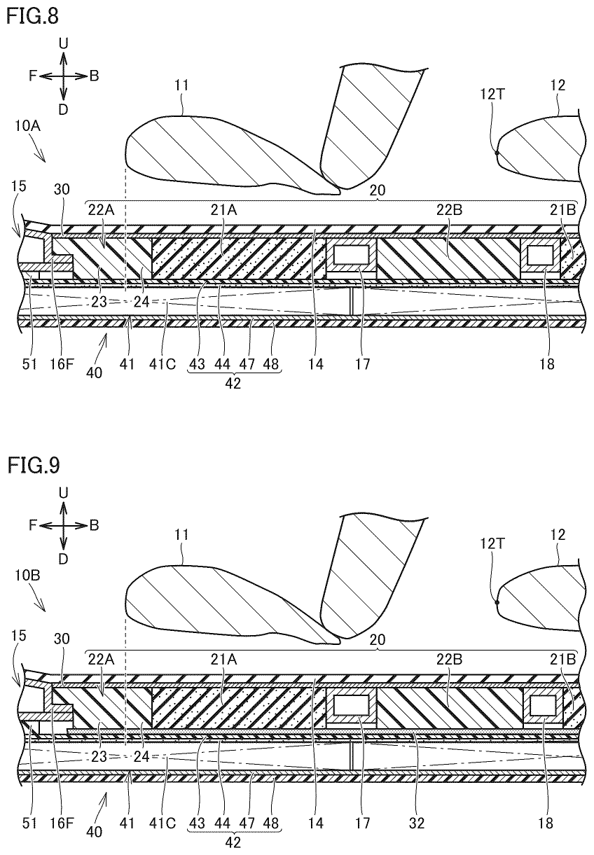

FIG. 8 is a cross sectional view showing a vehicle lower structure 10A in a second embodiment, which corresponds to FIG. 5 in the first embodiment. Vehicle lower structure 10A further includes a metal sheet 30 disposed between floor carpet 14 and each of first members 21A and 21B and second members 22A and 22B.

In the present embodiment, metal sheet 30 is disposed to contact two first members 21A and 21B and two second members 22A and 22B. Metal sheet 30 is satisfactory when it is disposed to contact at least one first member and at least one second member. Metal sheet 30 can be formed of aluminum foil or the like, for example. According to such a configuration, heat generated in power storage device 40 and directed upward, for example, can be dispersed in the horizontal direction at a height position of metal sheet 30.

Further, metal sheet 30 may be disposed to contact cross members 17 and 18. According to such a configuration, the heat generated in power storage device 40 and directed upward, for example, can be dispersed in the horizontal direction at the height position of metal sheet 30 and transferred to cross members 17 and 18.

Further, metal sheet 30 may be disposed to entirely cover first members 21A and 21B, second members 22A and 22B, and cross members 17 and 18 from above. According to such a configuration, it is possible to prevent air or the like from flowing from above metal sheet 30 toward intermediate member 20 below metal sheet 30, and to obtain a higher flame retardant effect below metal sheet 30.

### Third Embodiment

FIG. 9 is a cross sectional view showing a vehicle lower structure 10B in a third embodiment, which corresponds to FIG. 5 in the first embodiment. As shown in FIG. 9, vehicle lower structure 10B further includes an expansion member 32 disposed between cross members 17, 18 and power storage device 40 and expanding at least in the up/down direction by being heated.

Expansion member 32 expands by heating, and can increase the distance between intermediate member 20 and power storage device 40 by expanding and increasing its volume. Expansion member 32 may be constituted by a member including expanded graphite and a thermoplastic elastomer, for example. Expansion member 32 may also be constituted by a urethane-based resin or a silicone-based resin (such as a silicone sheet or a silicone rubber sheet). Expansion member 32 is not limited to having a sheet-like shape, and may be applied to a lower surface of intermediate member 20 or an upper surface of power storage device 40.

### Fourth Embodiment

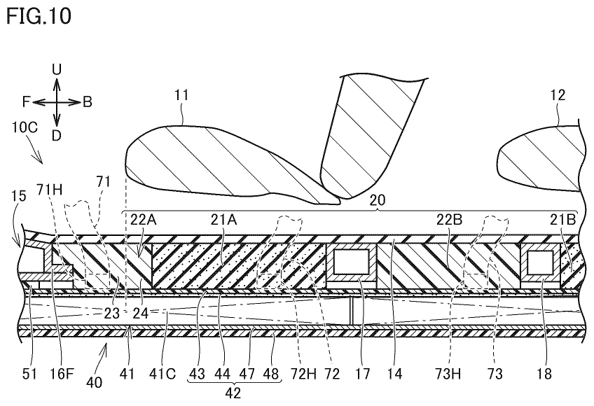

FIG. 10 is a cross sectional view showing a vehicle lower structure 10C in a fourth embodiment, which corresponds to FIG. 5 in the first embodiment. As shown in FIG. 10, a vehicle in the fourth embodiment includes ducts 71, 72, and 73 through which airflows generated by an air conditioning system for adjusting temperature in the vehicle compartment flow. Ducts 71, 72, and 73 have outlets 71H, 72H, and 73H, respectively, and outlets 71H, 72H, and 73H are provided to provide the airflows at positions between first members 21A, 21B or second members 22A, 22B and power storage device 40.

According to the above configuration, intermediate member 20 can be cooled by the airflows from the air conditioning system, and the heat from power storage device 40 can be suppressed from being transferred to the occupants.

Although the embodiments of the present disclosure have been described, it should be understood that the embodiments disclosed herein are illustrative and non-restrictive in every respect. The scope of the present disclosure is defined by the scope of the claims, and is intended to include any modifications within the scope and meaning equivalent to the scope of the claims.

What is claimed is:

1. A vehicle lower structure comprising:
a floor carpet forming a portion of a vehicle compartment;
an intermediate member disposed below the floor carpet;
a power storage device disposed below the intermediate member; and
a seat disposed above the floor carpet, wherein
the intermediate member includes
a first member underlying the seat in an up/down direction, and
a second member having an underlying portion underlying the seat in the up/down direction and a non-underlying portion not underlying the seat in the up/down direction, and
flame retardancy of the first member is higher than flame retardancy of the second member.

2. The vehicle lower structure according to claim 1, comprising a lower frame including a pair of side members, a front member connecting front portions of the pair of side members, a rear member connecting rear portions of the pair of side members, and a cross member connecting intermediate portions of the pair of side members in a vehicle front/rear direction, wherein
the intermediate member is disposed to fill a space formed by a plurality of members among the pair of side members, the front member, the cross member, and the rear member, inside the plurality of members.

3. The vehicle lower structure according to claim 1, wherein heat conductivity of the second member is lower than heat conductivity of the first member.

4. The vehicle lower structure according to claim 2, further comprising a metal sheet disposed between the floor carpet and each of the first member and the second member.

5. The vehicle lower structure according to claim 4, wherein the metal sheet is disposed to contact the cross member.

6. The vehicle lower structure according to claim 4, wherein the metal sheet is disposed to entirely cover the first member, the second member, and the cross member from above.

7. The vehicle lower structure according to claim 2, further comprising an expansion member disposed between the cross member and the power storage device and expanding at least in the up/down direction by being heated.

8. The vehicle lower structure according to claim 1, comprising a duct through which an airflow generated by an air conditioning system for adjusting temperature in the vehicle compartment flows, wherein
the duct has an outlet, and
the outlet is provided to provide the airflow at a position between the first member or the second member and the power storage device.
